(19) United States
(12) Patent Application Publication
(10) Pub. No.: US 2020/0063495 A1
(43) Pub. Date: Feb. 27, 2020

(54) LADDER COVER

(71) Applicant: David Rudd, Denver, CO (US)

(72) Inventor: David Rudd, Denver, CO (US)

(21) Appl. No.: 16/552,872

(22) Filed: Aug. 27, 2019

Related U.S. Application Data
(60) Provisional application No. 62/723,344, filed on Aug. 27, 2018.

(51) Int. Cl. E06C 7/48

(52) U.S. Cl. CPC E06C 7/48

(57) ABSTRACT

The present invention provides a ladder cover made up of fabric which prevents the marring of the wall from the top edges of the ladder, is enabled to couple to any ladder type and consists of a loop which secures construction tools to the ladder cover. The user wraps the ladder cover around the top edges of the side rails such that it covers the top edges completely. The wrapping of the cover is enabled by the coupling material such as Velcro which secures its position onto the side rails of the ladder. The cover further consists of adjustable loop on its top surface which enable the user to couple at least one construction tool at the time of use.

### CROSS-REFERENCE TO RELATED APPLICATIONS

This application claims benefit under 35 U.S.C. 119(e) of U.S. Provisional Application Ser. No. 62/723,344, filed Aug. 27, 2018, which is hereby expressly incorporated herein by reference in its entirety.

### FIELD OF THE INVENTION

The present disclosure is directed to a ladder cover, and more specifically to an adjustable ladder cover made up of a fabric-like material to prevent marring of a surface such as a wall, roofline or gutter from the edges of a conventional ladder near or at the ladder's point of contact with the surface.

### BACKGROUND OF THE INVENTION

Conventional extension ladders have a pair of side rails coupled by plurality of rungs. Ladders are placed on the ground such that the bottom portion of the ladder touches the ground and one or more edge portions of the ladder higher up on the ladder rest on the surface of a wall, roofline, or gutter. Typically, the one or more edge portions of the ladder lean on the surface such as a wall, roofline or gutter, from the edges of the ladder near or at the ladder's point of contact with the surface, with the ladder angled toward the wall.

During use, slight motion resulting from adjustment or positioning of the ladder on the surface leads to scraping and scratching of the surface which is highly undesirable. Moreover, during such motion, whether intended or unintended, the edges of the side rails of the ladder may slip during use, causing substantial risks resulting from the user falling, which may result in personal injury or may cause surface damage.

Many prior art items attempt to solve this problem. For example, U.S. Pat. No. 2,138,171 provides rubber tops to cover the top edges of the side rails, which purports to prevent the ladder from slipping from the wall. Separately, U.S. Pat. No. 4,726,446 provides a cover of insulating material made up of PVC from top edges of one side rail to another. Moreover, U.S. Pat. No. 3,993,163 provides a pad of resilient polyurethane foam wrapped on top edges of side rails, secured by a strap. Still, such solutions do not always optimally function. In some cases, the material such as rubber or PVC leads to marring of the paint of the wall. Moreover, each cover mentioned in prior art fits the top edge such that it cannot be used to any other ladder. Therefore, there remains an unmet need to solve challenges associated with the existing prior art.

### SUMMARY OF THE INVENTION

To overcome the drawbacks of the prior art, the present invention provides a cover made up of fabric configured to removably wrap around and affix to the leg of a ladder in a manner to prevent the marring of the surface. In various embodiments of the invention, the cover is enabled to couple to any ladder and further comprises a loop to secure construction tools during intended use.

In one embodiment, a cover is provided made up of a fabric or fabric-like material such as but not limited to suede and canvas which is thick enough to prevent the marring of the walls from the ladder's top edges. The user is enabled to wrap the cover around the top edges of the side rails such that it covers the top edges completely. The wrapping of the cover is enabled by the coupling material such as Velcro which secures its position onto the side rails of the ladder. The cover further consists of adjustable loop on its top surface which enable the user to couple at least one construction tool at the time of use.

Various embodiments of the present disclosure relate to a ladder cover of a conventional ladder's side rail. In one embodiment, the ladder cover is used as a pair, such that one ladder cover wraps around each of the typical ladder's two side rails. In the one embodiment, the cover is made of a fabric or padded plastic thick enough to cushion the rails of the ladder from the wall, gutter or roofline, configured such as to for prevent the marring of the wall, gutter or roofline. In the one embodiment, the cover is made of a flexible material such as fabric, so as to make the cover universally fitting to any ladder type. In an embodiment, the cover further consists of a loop for securing the construction tools at the time of use.

In another embodiment, the loop is integrally coupled to the cover.

In another embodiment, the cover is enabled to be coupled to the upper rungs of the ladder for having easy access to the construction tools.

### BRIEF DESCRIPTION OF THE DRAWINGS

The following drawings illustrates exemplary embodiments; however, they are helpful in illustrating objects, features and advantages of the present invention because in the one embodiment, the present invention will be more apparent from the following detailed description taken in conjunction with accompanying drawings, in which:

FIG. 1 is a perspective view of one embodiment of a ladder cover constructed in accordance with the present disclosure.

FIG. 2 is a back view of the ladder cover of FIG. 1.

FIG. 3 is a perspective view of the ladder cover removably attached to a conventional ladder.

FIG. 4 is a front view of the ladder cover of FIG. 3, the ladder cover completely attached to the ladder.

### DETAILED DESCRIPTION OF THE INVENTION

Before explaining at least one embodiment of the inventive concept disclosed herein in detail, it is to be understood that the inventive concept is not limited in its application to the details of construction, experiments, exemplary data, and/or the arrangement of the components set forth in the following description, or illustrated in the drawings. The presently disclosed and claimed inventive concept is capable of other embodiments or of being practiced or carried out in various ways. Also, it is to be understood that the phraseology and terminology employed herein is for purpose of description only and should not be regarded as limiting in any way.

In the following detailed description of embodiments of the inventive concept, numerous specific details are set forth in order to provide a more thorough understanding of the inventive concept. However, it will be apparent to one of ordinary skill in the art that the inventive concept within the disclosure may be practiced without these specific details. In other instances, well-known features have not been described in detail to avoid unnecessarily complicating the instant disclosure.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

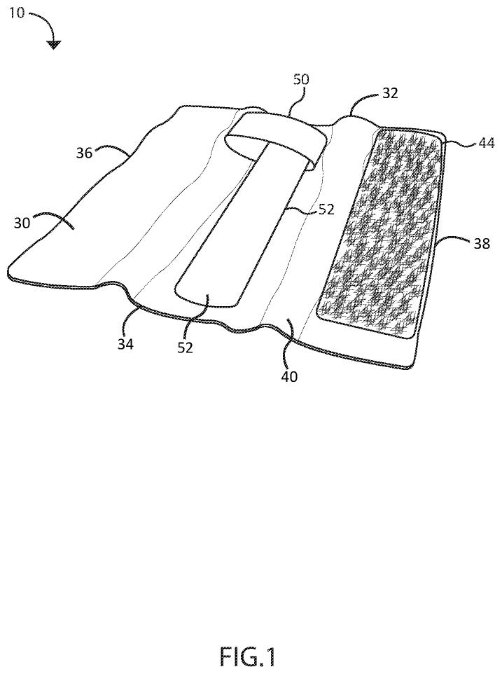

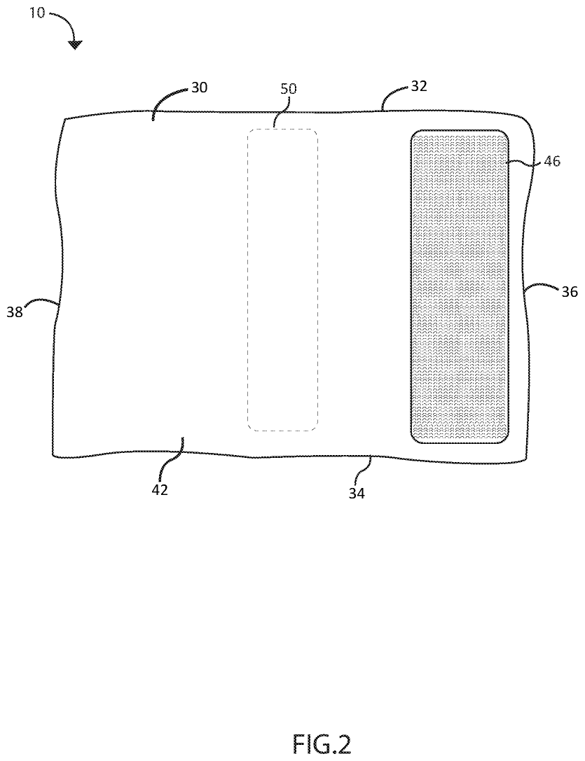

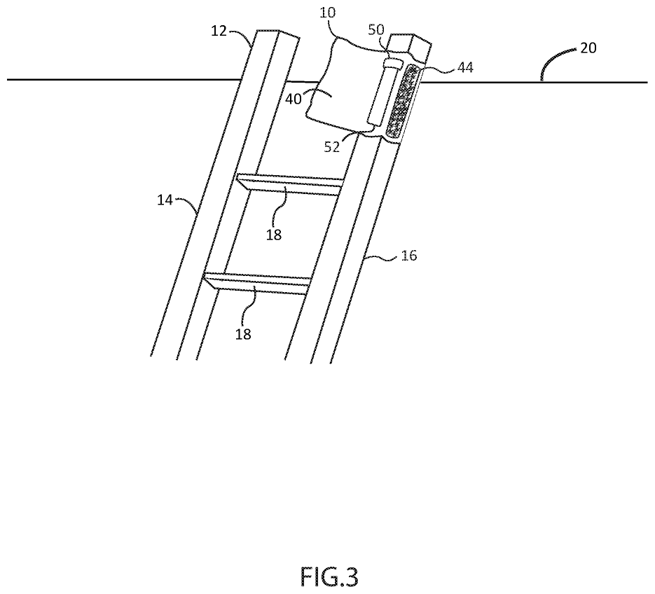

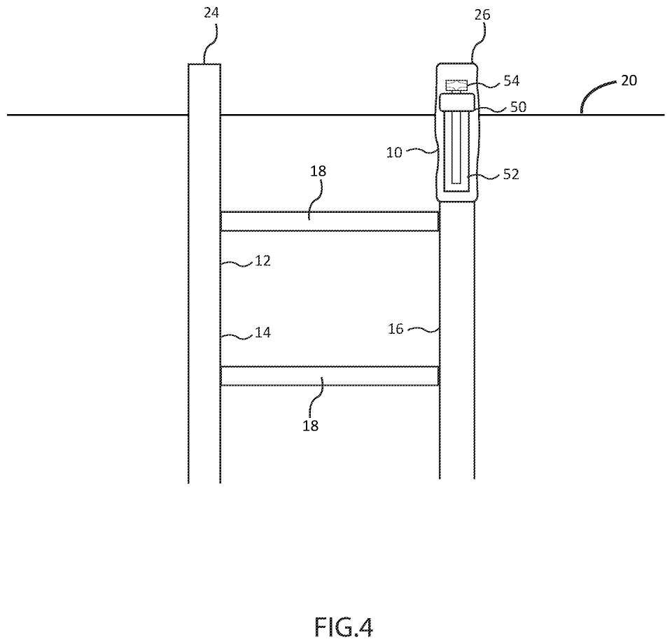

Referring to FIGS. 1-4, shown therein is a ladder cover 10 constructed in accordance with the present disclosure, the ladder cover 10 is removably attachable to a conventional ladder 12 having a pair of side rails 14 and 16 and a plurality of horizontal rungs 18 positioned and secured between the side rails 14 and 16. It is contemplated that the ladder cover 10 is constructed from one solid piece of material, however, it should be understood that the ladder cover 10 may be constructed from various components. The ladder cover 10 is preferably made of a durable and flexible material which is strong enough to prevent damage to the ladder 12 and to a surface 20 that supports a portion of the ladder 10. Suitable materials for construction of the ladder cover 10 and any components thereof include, by way of example, woven, non-woven fabric-like material, suede, canvas, leather, flexible material, or the like capable of providing the desired strength and durability for the ladder cover 10 in wrapping about the ladder 12. The material of the ladder cover 10 is thick enough for preventing the marring of a wall or other surface 20 by an edge 24 of the side rail 12 and an edge 26 of the side rail 16 of the ladder 12, wherein, in one embodiment, the thickness of the material is at least between 1-1.5 inches thick. The edges 24 and 26 at the top or near the top of the ladder 12 are positioned against the surface 20. The material may be water-resistant or waterproof so that the ladder cover 10 may be easily cleaned after use. Further, it will be appreciated that the ladder cover 10 can be sized and shaped from any suitable material, that is completely or partially positioned about a ladder in a manner that protects the ladder and/or otherwise functions as described herein. The ladder cover 10 is shown as substantially rectangular in shape, however, it should be understood that the ladder cover 10 or portions thereof may be any shape, such as circular, oval, square, rectangular, triangular, polygonal, quadrilateral, ellipsoidal and the like, for example. The ladder cover 10 may be flexible, semi-flexible, foldable, collapsible, and the like. It should be understood that the size and configuration of the ladder cover 10, and portions thereof, may vary widely dependent upon the size of the ladder and the area of which the ladder leans on for which protection is desired.

The ladder cover 10 includes a body 30 having an upper end 32, a lower end 34, a first side 36, a second side 38, a front surface 40 and a back surface 42. A coupling material 44 is provided on the front surface 40 and a corresponding coupling material 46 is provided on the back surface 42. The coupling materials can be any such material or item for connecting one item to another such as snaps, ties, clips, hook and loop, buckles, or any other means of fastening one object to another known to one of ordinary skill in the art.

A loop 50 is attachable to the front surface 40 and is adjustable with a coupling material 52. The loop 50 is configured to hold construction tools 54, such as, but not limited to a hammer, screwdriver, pliers, wrench, tape, scissors, or the like. In one embodiment, the loop 50 is made up of a material such as but not limited to nylon webbing and a hook and loop material or Velcro® to be coupled onto the cover 10 by the coupling material 52 such as but not limited to Velcro®. The loop 50 is adjustable on the coupling material 52 according to the size of the construction tool 54 to be coupled with the cover 10. In another embodiment, the loop 50 of the ladder cover 10 is integrally coupled to the ladder cover 10 by sewing, stapling, gluing, or any method known for securing one object to another object. In another embodiment, the loop 50 is configured to hold more than one construction tool.

In use, a user wraps the ladder cover 10 about the side rail 16 of the ladder 12 such that the top edge 26 of the side rail 16 is fully covered. The coupling of the cover 10 around the side rail 16 of the ladder (100) is enabled by attaching the coupling materials 44 and 46 to one another enabling the easy coupling and detachment of the ladder cover 10 to and from the ladder 12. The tool 54 is positioned in the loop 50 for holding the tool 54 so that the user can use the tool 54 as so needed. The ladder cover 10 is also wrapped in a similar manner about the side rail 14 of the ladder 12 such that the edge 24 of the side rail 14 is covered like the edge 26 of the side rail 16 of the ladder 12.

In another embodiment, the ladder cover 10 is coupled to one of the plurality of rungs 18 by wrapping the ladder cover 10 about the on of the plurality of rungs 18 in a similar manner as attaching the ladder cover 10 about the side rails 14 and 16 of the ladder 12. The ladder cover 10 is also enabled to be coupled to the upper rungs of the plurality of rungs 18 of the ladder 12 so that the user has an easy access to the construction tools 54 coupled to the ladder cover 10.

From the above description, it is clear that the present disclosure is well-adapted to carry out the objects and to attain the advantages mentioned herein, as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed herein.

What is claimed is:

1. A cover removably attachable to a ladder for covering the ladder and protecting a surface which supports the ladder, comprising:
a body having an upper end, a lower end, a first side, a second side, a front surface and a back surface wherein the front surface is provided with a first coupling material and the back surface is provided with a second coupling material such that the body is positioned about a portion of the ladder and the first and second coupling materials removably attach the body of the cover to the ladder.

2. The cover of claim 1 wherein the body is substantially rectangular.

3. The cover of claim 1 wherein the first coupling material is positioned about the second side of the front surface of the body.

4. The cover of claim 1 wherein the second coupling material is positioned about the first side of the back surface of the body.

5. The cover of claim 1 further comprising:
a loop attachable to the front surface of the body so as to adjustable with a third coupling material such the loop is configured to hold a tool.

6. The cover of claim 5 wherein the loop is configured to hold a plurality of tools.

7. The cover of claim 5 wherein the loop is secured to front surface of the body of the cover.

8. The cover of claim 1 wherein the body is positioned about a side rail of the ladder.

9. The cover of claim 1 wherein the body is positioned about at least one of a plurality of horizontal rungs of the ladder.

10. A method for positioning a ladder cover about a ladder, comprising the steps of:
providing a body having an upper end, a lower end, a first side, a second side, a front surface and a back surface wherein the front surface is provided with a first coupling material and the back surface is provided with a second coupling material;
positioning the back surface against a portion of the ladder; and
positioning the first side of the body about one side of the portion of the ladder and the second side of the body about the opposing side of the portion of the ladder so that the first and second coupling materials cooperate to hold the body of the ladder cover in a substantially secure position on the ladder.

11. The method of claim 10 further comprising the step of:
providing an adjustable loop removably connected to the front surface of the body of the ladder cover; and
adjusting the loop for receiving a tool.

12. The method of claim 11 further comprising the step of:
adjusting the loop for receiving a plurality of tools.

13. The method of claim 10 further comprising the step of:
removing the first side of the body away from the second side of the body such that the first coupling material is moved away from the second coupling material so that the body of the ladder cover is unwrapped about the portion of the ladder.

14. The method of claim 10 wherein the body is substantially rectangular.

15. The method of claim 10 wherein the first coupling material is positioned about the second side of the front surface of the body.

16. The method of claim 10 wherein the second coupling material is positioned about the first side of the back surface of the body.

17. The method of claim 10 wherein the loop is secured to front surface of the body of the cover.

18. The method of claim 10 wherein the body is positioned about a side rail of the ladder.

19. The method of claim 10 wherein the body is positioned about at least one of a plurality of horizontal rungs of the ladder.

20. The method of claim 10 wherein the coupling material is hook and loop material.
